(19) United States
(12) Patent Application Publication
(10) Pub. No.: US 2026/0199900 A1
(43) Pub. Date: Jul. 16, 2026

(54) APPARATUSES AND METHODS INVOLVING SPATIOTEMPORAL SEQUENCING OF DROPLET ASSAYS

(71) Applicant: The Board of Trustees of the Leland Stanford Junior University, Stanford, CA (US)

(72) Inventors: Juan G. Santiago, Stanford, CA (US); Alexandre Avaro, Stanford, CA (US)

(21) Appl. No.: 19/136,621

(22) PCT Filed: Jan. 2, 2024
(86) PCT No.: PCT/US2024/010072

§ 371 Date: Jun. 6, 2025

Related U.S. Application Data
(60) Provisional application No. 63/436,728, filed on Jan. 3, 2023.

(51) Int. Cl. B01L 3/00

(52) U.S. Cl. CPC B01L 3/502784; B01L 2200/027; B01L 2200/0673; B01L 2300/0867; B01L 2300/088

(57) ABSTRACT

A particular microfluidic assay example uses spatiotemporal sequencing of droplet assays. The method includes differentiating discrete volumes (“droplets”) of different samples in a microfluidic chamber (or channel) for differentiation of the droplets, via coding of the droplets based on spatiotemporal sequencing of the droplets (e.g., encoded via their movement into the microfluidic device to form a temporal order that is at least partially preserved as a spatial pattern), and certain of the droplets of different groups may be created to encapsulate respective chemicals (e.g., each of the different groups having a single type of molecule), and in at least one location within the microfluidic chamber one type of the different groups may have a spatial order that is consistent with the spatiotemporal sequencing. Further, groups of one type may have a spatial order within the secondary region that is monotonic with a related initial temporal order.

### BACKGROUND

Aspects of the present disclosure are related generally to the field of microfluidics.

Using one such technology type for ease of discussion, it has been appreciated that “droplet-based” microfluidics systems leverage the creation of discrete volumes (droplets) within a carrier, immiscible fluid (e.g., oil). The small length scales of the droplets (with typical volumes on the order of nano-or femtoliters) imply short heat and mass transfer time scales. Droplet microfluidics systems also enable the design, control, and readout of easily reconfigurable assays involving a large number of parallel reactions. The formation of droplets has been studied extensively and techniques to produce highly monodisperse droplets have been widely described and implemented. After their formation, droplets are typically directed into a point-detector where reaction products are detected in several ways. For example, they can be detected one droplet at a time, and directed into a larger chamber for imaging on-chip or flowed into an output reservoir where they can be collected and analyzed off chip (e.g. by pooling together and then sequencing).

There is a need for high-throughput, massively multiplexed droplet-based assays for a variety of applications such as drug discovery and cancer screening. Certain commercial products offer microfluidic chips that combine droplet creation, storage, and fluorescence observation with different colors of fluorescent dye, but their multiplexing capabilities are very limited and they are not addressing the market's needs (e.g., which in some instances are on the order of about 100 or more parallel reactions).

Multiplexing droplet-based microfluidics systems are currently limited by several technological challenges. For example, the finite spectral width of excitation and emission spectra of fluorescence markers limit the number of multiplexing channels achievable in multicolor systems. Intensity-based methods have shown up to 5-plex reactions using two colored probes. Other methods rely on inserting and identifying unique labels into each droplet of the analysis. For example, droplets can be loaded with “barcode” sequences encased in gel beads which are then used to identify reaction products with off-chip, downstream sequencing.

Current detection and discrimination techniques rely on several methods of multiplexing including multiple fluorescence dyes, barcoding of droplets using barcoded particles, and barcoding using gel beads containing barcoded synthetic DNA. In the case of labeling samples by color, the current typical approach is to use a single one-to-one correspondence between a reaction and a fluorescence emission wavelength band. For example, commercial products use up to six colors of dyes with a one-to-one correspondence between reaction and color. Multiplexing by color is convenient but fundamentally limited at least by the finite width of the emission wavelength bands of markers. Moreover, there is a need for a much higher degree of multiplexing.

Accordingly, the above and other issues involving microfluidic assaying are limited.

### SUMMARY OF VARIOUS ASPECTS AND EXAMPLES

Various examples/embodiments presented by the present disclosure are directed to issues such as those addressed above and others which may become apparent from the following disclosure. For example, some of these disclosed aspects are directed to methods (of use and/or manufacture) and devices that may be used in connection with improving the degree of multiplexing of droplet-based microfluidic assays, in various respective example embodiments and compared to current techniques by differentiating samples in droplet-based microfluidics assays based on (e.g., fluorescent) signal and droplet position, and/or by improving multiplexing of droplet-based microfluidic assays significantly, by an order of magnitude, or by several orders of magnitude.

In certain examples according to the present disclosure, example embodiments disclosed herein enable multiplexing based solely on encoding of multiple samples by the sequence of droplet formations and the subsequent spatial positioning of droplets in a constrained, poorly mixed output region. Different, respective example embodiments use four (or more) different dyes in combination with spatial positioning to achieve N-sample multiplexing (e.g., with N being twenty-four, greater than twenty-four, at least forty-eight, etc.).

In one example, a method includes differentiating discrete volumes (“droplets”) of different samples in a microfluidic chamber or channel for differentiation of the droplets, via coding of the droplets based on spatiotemporal sequencing of the droplets.

In another specific example, a method includes combining discrete volumes (“droplets”) of different samples in a microfluidic chamber or channel of an assay system while encoding the discrete volumes via spatiotemporal sequencing of the discrete volumes in one or more immiscible fluids. The example method further includes causing the different samples to move in the microfluidic chamber or channel for assessment of one or more reactions specific to one or more certain molecules or molecular structures.

According to another related aspect, an apparatus (e.g., a system, device, component, etc.) includes a plurality of microfluidic containers and a microfluidic chamber or channel. The microfluidic chamber or channel is to assay differentiable discrete volumes (“droplets”) of different samples in a microfluidic chamber or channel by differentiation of the droplets, via coding of the droplets based on spatiotemporal sequencing of the droplets.

The plurality of microfluidic containers are to fluidically couple the respectively differentiable droplets with the microfluidic chamber or channel while the droplets are coded based on the spatiotemporal sequencing.

Certain other examples which may also build on the above-discussed aspects, methods and semiconductor structures are directed to one or more of the following aspects or attributes: the droplets are encoded via their movement into the microfluidic device to form a temporal sequence that is at least partially preserved (relative to an earlier position in the chamber or channel) as a spatial pattern; certain of the droplets of different groups are created to encapsulate or embrace respective chemicals, wherein each of the different groups contains a single type of molecule, and in at least one location within the microfluidic chamber or channel, one type of the different groups has a spatial order that is consistent with the spatiotemporal sequencing; and droplets of different groups are created to encapsulate respective chemicals, wherein each group of droplets contains a single type of molecule and wherein groups of one type have a spatial order within a secondary region of the chamber or channel that is monotonic with a temporal order associated with another initial region of the chamber or channel. Further, the approach may involve causing the different samples to move in the microfluidic chamber or channel for assessment of reactions specific to one or more certain molecules or molecular structures.

In other more specific examples related to the above methodology and/or apparatuses (which may also build on one or more of the above-discussed aspects), such examples may include one or more of: coding of the droplets including encoding the droplets based on the spatiotemporal sequencing of the droplets by causing the droplets to move in one or more immiscible fluids; moving the droplets in the microfluidic device and, subsequently, assessing certain of the droplets; and conducting testing, at an assessment region coupled to or integrated as part of the chamber or channel, for one or more reactions specific to one or more certain molecules or molecular structures.

Further specific example embodiments may include or involve (alone or in combination with one or more of the other such example aspects and/or embodiments): multiple samples encoded by the sequence of droplet formations, spatially positioned droplets in an output region (e.g., which is a constrained, poorly-mixed output region); different dyes in combination with spatially positioned droplets in an output region for N-sample multiplexing (where N is an integer≥2); encoding of multiple samples by the sequence of droplet formations, spatial positioning of droplets in an output region (e.g., which is a constrained, poorly-mixed output region); spatially-based multiplexing or distinguishing of droplet assays with the spatial location of output drops being based on or related to times of injection or to the original species they are most likely to contain, and/or based on the relation between droplet location and the sequencing of sample injections; spatially-based multiplexing or distinguishing of droplet assays being related to or based on tracking the number of droplets created per sample and the order of injection, and/or using these aspects to match droplets with the samples from where they originate (e.g., by measuring its position and its signaling which may be, as an example, fluorescent signaling); spatially-based multiplexing or distinguishing of droplet assays being related to or based on tracking the volume injected into the microfluidic device per sample and the order of injection, and/or using these aspects to match droplets with the samples from where they originate (e.g., by measuring its position and its signaling which may be, as an example, fluorescent signaling); at least four different dyes in combination with spatial positioning and with or for at least 48-sample multiplexing; differentiation of the sample in droplet-based microfluidics assays based on (e.g., fluorescent) signal and droplet position; and a multiplexed droplet-based system used in connection with at least one of cancer screening and efforts to discover a treatment or drug.

Certain other specific example aspects of the present disclosure are directed to methods and/or apparatuses involving or including: multiplexing by color without being limited to a one-to-one correspondence between reaction and color; and/or microfluidic chips that combine droplet creation, storage, and/or fluorescence observation, and with multiplexing capabilities (e.g., six colors or more) and/or so as to address the needs of application in current markets (e.g., approaching, on the order of ~100 parallel reactions, or much greater than 100 parallel reactions).

The above discussion is not intended to describe each aspect, embodiment or every implementation of the present disclosure. The figures and detailed description that follow also exemplify various embodiments.

### BRIEF DESCRIPTION OF FIGURES

Various example embodiments, including experimental examples, may be more completely understood in consideration of the following detailed description in connection with the accompanying drawings, each in accordance with the present disclosure, in which:

FIGS. 1A and 1B are respective diagrams showing multiplexing strategies and related geometric aspects for droplet-based assays according to the present disclosure; and

FIG. 2 is another diagram showing an alternative approach and related geometric aspects for multiplexing of droplet-based assays according to the present disclosure.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Certain aspects of the present disclosure are believed to be applicable to a variety of different types of apparatuses (e.g., systems and devices) and methods involving spatial-based multiplexing of droplet assays and/or involving differentiation of samples in droplet-based microfluidics assays through the use of an external signal reacting with structures at the molecular level (e.g., molecules or molecular-specific structures) as occurs in the case of fluorescent signaling where fluorescent molecules absorbing light of one color and emitting light of a different color and droplet position. One exemplary method according to the present disclosure includes differentiating discrete volumes (“droplets”) of different samples in a microfluidic chamber or channel for differentiation of the droplets, via coding of the droplets based on spatiotemporal sequencing of the droplets. While the present disclosure is not necessarily limited to such aspects, an understanding of specific examples in the following description may be understood from discussion in such specific contexts.

In another example embodiment according to the present disclosure, a method includes differentiating the droplets of different samples in a microfluidic chamber or channel for differentiation of the droplets, via coding of the droplets based on spatiotemporal sequencing of the droplets, with the droplets being created in a first region of the microfluidic device and being encoded by moving them into a secondary region within the microfluidic device such that the temporal order in which they enter the secondary region is at least partially preserved as a spatial pattern in the secondary region. Further, in this type of example, the method may include certain droplets of different groups being created to encapsulate respective chemicals, wherein each group of droplets contains a single type of molecule and wherein groups of one type have a spatial order within the secondary region that is monotonic with the temporal order within which they enter. The approach may also involve causing the different samples to move in the microfluidic chamber or channel for assessment of reactions specific to one or more certain molecules or molecular structures.

Certain other examples which may also build on the above-discussed aspects, concern methods and semiconductor structures which are directed to one or more of the following aspects or attributes: coding of the droplets including encoding the droplets based on the spatiotemporal sequencing of the droplets by causing the droplets to move in one or more immiscible fluids; moving the droplets in the microfluidic device and, subsequently, assessing certain of the droplets; conducting testing, at an assessment region coupled to or integrated as part of the chamber or channel, for one or more reactions specific to one or more certain molecules or molecular structures; and optionally, the coding of the droplets including decoding the droplets based on movement of the droplets relative to one or more temporal patterns (e.g., as another way to show the relation between temporal and spatial coding).

In certain more-specific (e.g., experimental/proof-of-concept) example embodiments, aspects include one or more of the following (alone or in combination with one or more of the other such example aspects and/or embodiments): multiple samples being encoded by the sequence of droplet formations, spatially-positioned droplets in an output chamber region (e.g., a constrained, poorly-mixed output region); encoding of multiple samples by the sequence of droplet formations, spatial positioning of droplets in an output region (e.g., which is a constrained, poorly-mixed output region); different dyes in combination with spatial positioning for N-sample multiplexing (where N is an integer≥2); spatially-based multiplexing or distinguishing of droplet assays with the spatial location of output drops being based on or related to times of injection and/or to the original species they are most likely to contain and/or based on the relation between droplet location and the sequencing of sample injections; spatially-based multiplexing or distinguishing of droplet assays being related to or based on tracking the number of droplets created per sample and the order of injection, and/or using these aspects to match droplets with the samples from where they originate (e.g., by measuring its position and its signaling which may be, as an example, fluorescent signaling); spatially-based multiplexing or distinguishing of droplet assays being related to or based on tracking the volume of sample injected into the microfluidic device per sample and the order of injection, and/or using these aspects to match droplets with the samples from where they originate (e.g., by measuring its position and its signaling which may be, as an example, fluorescent signaling); at least four different dyes in combination with spatial positioning and with or for at least 48-sample multiplexing; differentiation of sample in droplet-based microfluidics assays based on (e.g., fluorescent) signal and droplet position; at least four different dyes in combination with spatial positioning and with or for at least 48-sample multiplexing; and a multiplexed droplet-based system used in connection with at least one of cancer screening and efforts to discover a treatment or drug.

Certain other specific example aspects of the present disclosure are directed to methods and/or apparatuses involving or including: multiplexing by color without being limited to a one-to-one correspondence between reaction and color; and/or microfluidic chips that combine droplet creation, storage, and/or (e.g., fluorescence) observation. Some of these specific aspects may be implemented with multiplexing capabilities (e.g., of greater than a maximum of six colors) and/or to address needs of application in current markets including but not limited to those requiring or benefiting from needing such assay processing to occur at levels approaching or on the order of tens of parallel reactions and in some instances much greater than 100 parallel reactions (e.g., several hundred to a thousand parallel reactions).

Accordingly, in the following description various specific details are set forth to describe specific examples presented herein. It should be apparent to one skilled in the art, however, that one or more other examples and/or variations of these examples may be practiced without all the specific details given below. In other instances, well-known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination. Consistent with the above aspects, such a manufactured device or method of such manufacture may involve aspects presented and claimed in U.S. Provisional Application Ser. No. 63/436,728 filed on Jan. 3, 2023 (STFD.448P1 S22-501), to which priority is claimed. To the extent permitted, such subject matter is incorporated by reference in its entirety generally and to the extent that further aspects and examples (such as experimental and/more-detailed embodiments) may be useful to supplement and/or clarify.

In certain specific contexts and applications, example aspects and/or example embodiments are directed to addressing technological challenges and/or limitations in currently-available droplet-based microfluidics systems. For example, in certain applications the finite spectral width of excitation and emission spectra of fluorescence markers, which may be used to facilitate distinguishing molecular structures, limit the number of multiplexing channels achievable in multicolor systems, and intensity-based methods have shown up to five-plex reactions using two colored probes. See, e.g., the first two (“1” and “2”) of the various background references cited among those included as part of the above-referenced U.S. Provisional Application. Other known methods rely on inserting and identifying unique labels into each droplet of the analysis. For example, droplets can be loaded with “barcode” sequences encased in gel beads which are then used to identify reaction products with off-chip, downstream sequencing.

For many applications, aspects of the present disclosure provide practical improvements over such known methods. For example, certain aspects or embodiments according to the present disclosure enable multiplexing based solely on encoding of multiple samples by the sequence of droplet formations and the subsequent spatial positioning of droplets in a constrained, poorly-mixed output region. One such embodiment uses X (e.g., four, seven, eight, or more) different dyes in combination with spatial positioning to achieve N-sample multiplexing (e.g., with N being at least twenty four or at least forty eight).

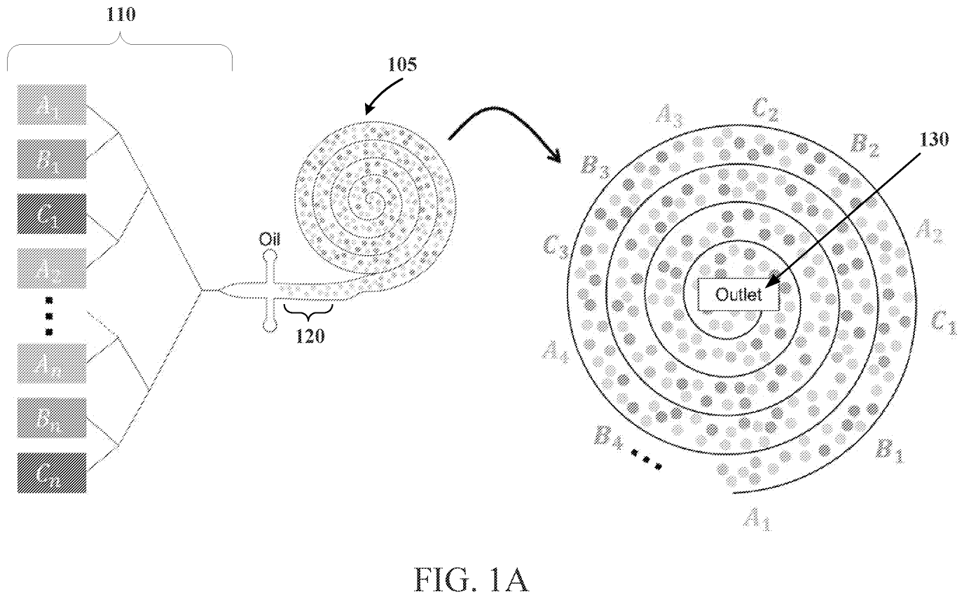

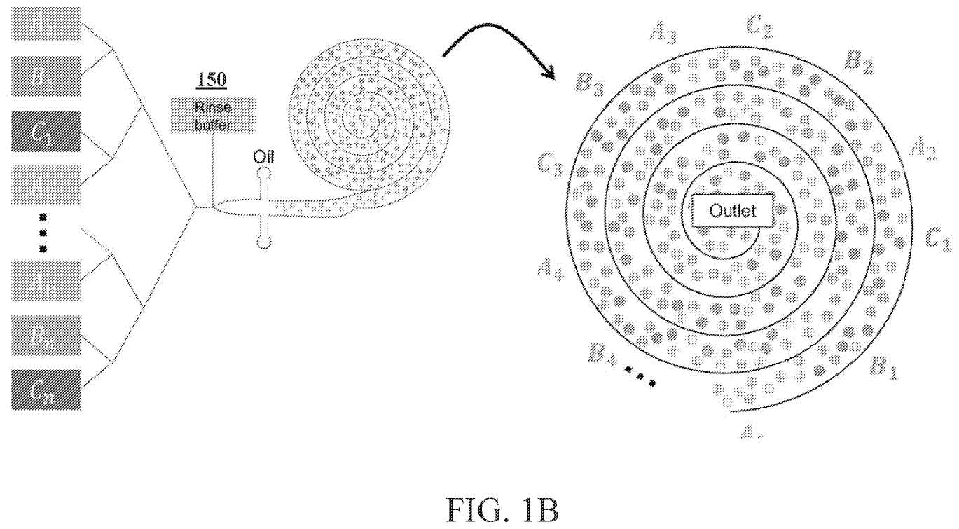

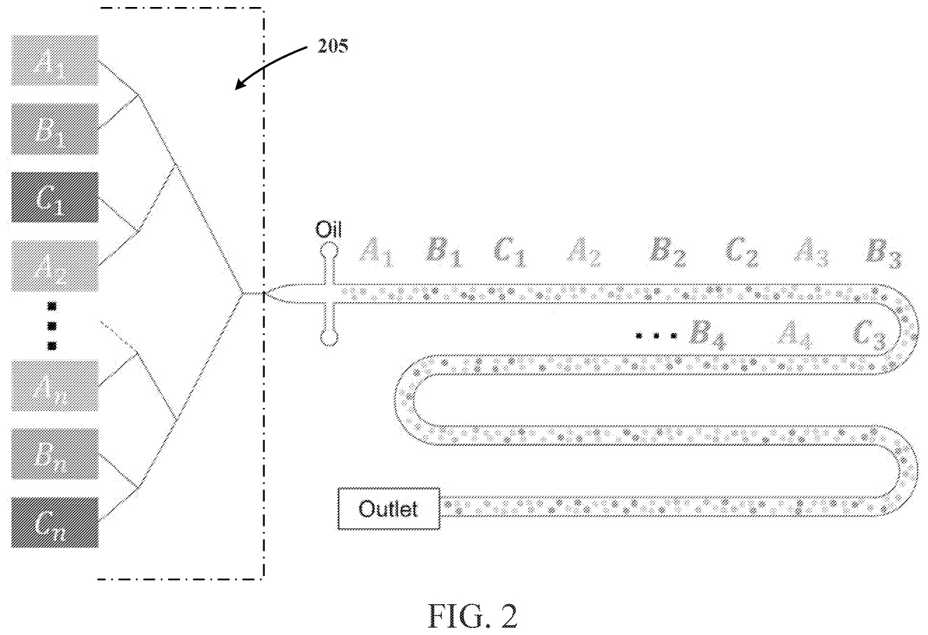

According the present disclosure, one or more of the above-noted limitations may be addressed by the types of specific example embodiments shown in the Figures. Each of FIGS. 1A, 1B and 2 are useful in illustrating the above-discussed methodology and related aspects through use of an apparatus that includes a microfluidic chamber or channel, and a plurality of microfluidic containers. The microfluidic chamber or channel is for assay of differentiable discrete volumes (“droplets”) of different samples by differentiation of the droplets, via coding of the droplets based on spatiotemporal sequencing of the droplets. The microfluidic containers are to fluidically couple the respectively differentiable droplets with the microfluidic chamber or channel while the droplets are coded based on the spatiotemporal sequencing.

In a typical application, each microfluidic container may include a chamber 105 (as shown in FIG. 1A, and which may correspond to at least one of a microfluidic chamber and microchannel) to store one of the respectively differentiable droplets before being introduced to the microfluidic channel, and a microfluidic sample mixer (e.g., illustrated by way of a sample injector at 110 of FIG. 1A) which is to selectively pass the respectively differentiable droplets to an input region (e.g., 120 of FIG. 1A) of the microfluidic chamber or channel using N-sample multiplexing (N being a positive integer such as twenty-four), to cause the droplets to be coded with spatial positioning consistent with the spatiotemporal sequencing, and wherein the microfluidic chamber or channel includes an output region (e.g., “outlet” 130 of FIG. 1A) wherein the droplets are moved after passing through a main portion of the microfluidic channel. In this way, the microfluidic sample mixer selectively passes the N samples (corresponding to the respective droplets) to an input region using N-sample multiplexing, where N is an integer of at least four, to cause the droplets to be coded, via at least four different dyes, with spatial positioning consistent with the spatiotemporal sequencing.

The specific example of FIG. 1A may be more-specifically described as follows. A number of samples (N samples) are stored off a main microfluidic chip and directed into the chip with standard tubing and tube-to-reservoir connections (N being a positive integer such as at least twenty-four or at least forty-eight). The N samples are introduced in top-to-bottom order (e.g. the green-labeled sample first, then orange, then blue, then another green sample, etc.). Each of the reservoirs feeds a unique sample into an inlet channel. These N inlet channels then supply an on-chip microfluidic network designed to introduce some small volume of each sample into one droplet at a time. Alternately, the network can provide and mix small volumes from small number of samples into one droplet at a time. In certain examples, this on-chip network includes low degree of mixing between samples and low dead volume. The on-chip nature of the microchannels can help reduce dead volume. One way to reduce mixing is to partially flush sections of the network containing sample species from a previous injection using liquid from rinsing buffer channels.

Also according the present disclosure, FIG. 1B shows another example embodiment wherein every odd number of the N input chambers is filled with rinse buffer 150 (no sample) for the purpose of flushing out sections of the network to decrease cross-contamination among samples.

An example feature according to the present disclosure (applicable to each of the examples of the present disclosure) is the spatial location of output drops and their relation to the times of injection and, therefore, the original sample species they are most likely to contain. FIGS. 1A and 1B show droplets being fed into a spiral output channel (with an outlet at the center of the spiral). The spiral channel allows for a few droplets (say three to four droplets) across the width, confines the positioning and can reduce the amount of mixing among the output droplets. Hence, droplet position along the spiral output channel is strongly correlated with the order of their formation and therefore their position along the contour of the channel. For example, if droplet A is formed before droplet B then it is more likely to find droplet A at a more downstream position than droplet B at any time.

In certain specific embodiments according the present disclosure, examples are directed to a strategy that relies on the relation between droplet location and the sequencing of sample injections. In the embodiment shown in FIG. 1A, a three-color system is used to make the system robust to small amounts of mixing in the output stream. For example, consider a system with 48 input samples (plus any rinsing buffer inputs). The 48 samples could be labeled with three different colors to create three color groups, each of which includes 16 unique samples. By keeping track of the number of droplets created per sample and the order of the injection, each droplet can be matched with the sample it originates from by measuring its position and its fluorescent signal. The three colors mean that, for example, a blue-type droplet injected after an orange one can mix with the orange group ahead of it, but its blue signal will not be confused with any of the orange group. The orange-type drop would have to pass the blue group and then the adjoining green group before it would be confused with the “older” orange group. In this way, formed droplets periodically cycle through a fix set of dyes where the number of required dyes can be much less than the number of samples. Because droplet formation and arrangement in the output is very regular, each droplet is correctly associated with its appropriate group.

In other example embodiments also according to the present disclosure, some or all of the rinsing solutions streams (e.g., as in FIG. 1B) are labeled with some marker (e.g., a unique, fourth dye color or particles). This labeling may be used to facilitate keeping track of the so-called “dummy” droplets created by the rinsing solution. Moreover, in certain specific applications this approach may help attribute “negative” results of the assay versus rinse-buffer-filled droplets.

Also according to the present disclosure, FIG. 2 shows another example output channel in the form of horizontal channel sections separated by 180 degrees turns. The robustness of this two-fold discrimination method increases with the number of colors of fluorescent dyes. Moreover, the degree of multiplexing is now determined largely by the geometry of the microfluidic chip (a customizable parameter) rather than by the bandwidth of the visible spectrum (a fundamental physical parameter).

In each of FIGS. 1A and 1B (collectively FIG. 1) and FIG. 2, and if viewed in color, the annotations: A₁, A₂ . . . Aₙ are shown in light green along the left and along the channel (with corresponding droplets similarly colored below A₁, A₂ . . . Aₙ; B₁, B₂ . . . Bₙ are shown in orange along the left and along the channel (with corresponding droplets similarly colored below B₁, B₂ . . . Bₙ, and C₁, C₂ . . . Cₙ are shown in orange along the left and along the channel (with corresponding droplets similarly colored below C₁, C₂ . . . Cₙ.

More particularly, FIGS. 1A and 1B are useful for illustrating a multiplexing strategy, according to another related aspects of the present disclosure, for droplet-based assays. In using this strategy, each sample goes through an inlet tree (left), to droplet formation (cross) and finally to storage (right). Each sample Xᵢ is identified by a zone (position of the group of droplets, numbers) and a color (e.g., alternating between a given number of fluorescent dye, letter).

Two example embodiments are presented here. FIG. 1A shows a less-complex embodiment from among the examples disclosed herein. FIG. 1B shows the same geometry with a rinsing buffer that would flush out dead volume between two consecutive inputs of sample, thereby helping to prevent cross-contamination among samples.

FIG. 2 illustrates a multiplexing strategy for droplet-based assays with alternative geometry. This geometry presents a similar structure as in FIGS. 1A and 1B (with inputs, droplet generation and storage) but the storage geometry here being constituted of horizontal channels separated by 180 degrees turns. For example, the encoding of the droplets includes causing the droplets to move within the microfluidic device such that, while still within the microfluidic device, a previous temporal order of the droplets is at least partially preserved as a spatial pattern after the droplets are caused to move within the microfluidic device.

Accordingly, discrete volumes (“droplets”) of different samples are used in the microfluidic chamber or channel for differentiation of the droplets, by way of coding the droplets based on spatiotemporal sequencing of the droplets, and with use of a droplet-introducing multiplexer (e.g., depicted as 205 via dashed lines in FIG. 2) for introducing the droplets to the device (e.g., a set of channels). The spatiotemporal sequencing of the droplets may be decoded for any of many applications include laboratory-based or clinical testing and/or experimentation as may be used in evaluating or discovering a treatment or a drug.

Various fluidic mechanisms may be used to multiplex and introduce the samples to the elongated microfluidic channel. Non-limiting examples include: passive micro-mixers, active micro-mixers, and micro-mixers involving both active and passive forces. See https://www.sciencedirect.com/science/article/pii/S0009250921005716. In certain other (non-limiting) specific examples, exemplary aspects of the present disclosure may involve use of a conventional multiplexer and related multiplexing instruments, for example, as commercially available from Bio Rad (see https:/www.bio-rad.com/ and https://www.bio-rad.com/SearchResults?search_api_fulltext=multiplex) or Elveflow (https://www.elveflow.com/microfluidic-applications/setup-droplet-and-digital-microfluidics/sequential-production-and-trapping-of-droplets/).

Further and as depicted in each of the illustrated examples, oil is used as the basis of one of more immiscible fluids in connection with the movement of the droplets. Thus, the coding of the droplets may include encoding the droplets based on the spatiotemporal sequencing of the droplets by causing the droplets to move in such oil (e.g., with droplets including culture media and/or cells contained under such an oil overlay).

It is recognized and appreciated that as specific examples, the above-characterized figures and discussion are provided to help illustrate certain aspects (and advantages in some instances) which may be used in the manufacture of such structures and devices. These structures and devices include the exemplary structures and devices described in connection with each of the figures as well as other devices, as each such described embodiment has one or more related aspects which may be modified and/or combined with the other such devices and examples as described hereinabove may also be found in the above-referenced Provisional Application.

The skilled artisan would also recognize various terminology as used in the present disclosure by way of their context. As examples, the Specification may describe and/or illustrates aspects useful for implementing the examples by way of various devices such as fluidic manipulation equipment and/or tools (e.g., slides, substrate-related materials such as glass, coverglass, chambers of various shapes including chambers with channels), which may be illustrated as or using more generalized terms such as fluidic container, blocks, modules, device, system, unit, and/or other depictions. In certain instances, terms such as chamber or channel are used in the context of manipulation (e.g., causing movement(s) or reaction(s)), and while such terms have carry overlapping meanings, in some instances or contexts a chamber may be different than a channel (e.g., a channel may have a cavity feature along a portion of the channel). Also, in connection with such descriptions and terms, such equipment or tools may be used together with other elements and steps to exemplify how certain examples may be carried out in the form or structures, functions, operations, activities, etc. It would also be appreciated that terms to exemplify orientation, such as upper/lower, left/right, top/bottom, horizontal/vertical and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure, including aspects set forth in the claims.

1. A method comprising:
differentiating discrete volumes (“droplets”) of different samples in a microfluidic chamber or channel for differentiation of the droplets, via coding of the droplets based on spatiotemporal sequencing of the droplets, wherein introduction of the droplets to the microfluidic chamber or channel effects an order, for at least one of time and space, which order is preserved for at least an initial region of the chamber or channel.

2. The method of claim 1, wherein the droplets are encoded via their movement into the microfluidic chamber or channel to form a temporal order that is at least partially preserved as a spatial pattern.

3. The method of claim 1, wherein certain of the droplets of different groups are created to encapsulate or embrace respective chemicals, wherein each of the different groups contains a single type of molecule, and in at least one location within the microfluidic chamber or channel one type of the different groups has a spatial order that is consistent with the spatiotemporal sequencing.

4. The method of claim 1, wherein droplets of different groups are created to encapsulate respective chemicals, wherein each group of droplets contains a single type of molecule and wherein groups of one type have a spatial order within a secondary region of the chamber or channel that is monotonic with a temporal order associated with another initial region of the chamber or channel.

5. (canceled)

6. The method of claim 1, wherein the coding of the droplets includes encoding the droplets based on the spatiotemporal sequencing of the droplets by causing the droplets to move in one or more immiscible fluids.

7. The method of claim 1, wherein the droplets are moved in the microfluidic chamber or channel and, subsequently, certain of the droplets are assessed.

8. The method of claim 1, further including conducting testing, at an assessment region coupled to or integrated as part of the chamber or channel, for one or more reactions specific to one or more certain molecules or molecular structures.

9. The method of claim 1, wherein the coding of the droplets includes decoding the droplets based on movement of the droplets relative to one or more temporal patterns.

10. The method of claim 1, further including sorting one or more of the droplets based on said differentiating of the droplets.

11. The method of claim 1, further including assessing time-based attributes corresponding to the spatiotemporal sequencing of the droplets; and spatial attributes corresponding to the spatiotemporal sequencing of the droplets.

12. (canceled)

13. The method of claim 1, further including sorting or assessing differentiated ones of the droplets based on attributes of the spatiotemporal sequencing of the droplets.

14. The method of claim 1, further including: causing the droplets to move within one or more immiscible fluids; assessing time-based attributes corresponding to the spatiotemporal sequencing of the droplets; assessing spatial attributes corresponding to the spatiotemporal sequencing of the droplets; and sorting differentiated ones of the droplets based on at least one of the time-based attributes and spatial attributes of the spatiotemporal sequencing.

15. The method of claim 1, further comprising:
combining the droplets of different samples in the microfluidic chamber or channel of an assay system while the discrete volumes are coded via the spatiotemporal sequencing of the droplets in one or more immiscible fluids; and
causing the different samples to move in the microfluidic chamber or channel for assessment of one or more reactions specific to one or more certain molecules or molecular structures.

16. The method of claim 15, wherein combining of the droplets includes multiplexing using a plurality of the different samples and a plurality of different respective dyes, and the droplets are encoded by causing the droplets to move within the microfluidic chamber or channel such that, while still within the microfluidic device, a previous temporal order of the droplets is at least partially preserved as a spatial pattern after the droplets are caused to move within the microfluidic device.

17. The method of claim 15, wherein the different samples move in the microfluidic chamber or channel to an assessment region that is coupled to the channel, and the method further includes differentiating certain of the samples based on signal and droplet position.

18. The method of claim 15, further including calculating, via computing processor circuitry, at least one of: spatial attributes for the spatiotemporal sequencing of the discrete volumes; and time-based attributes for the spatiotemporal sequencing of the discrete volumes.

19.-21. (canceled)

22. An apparatus comprising:
a microfluidic chamber or channel, for assay of differentiable discrete volumes (“droplets”) of different samples, and
the microfluidic chamber or channel having an introduction or input region at which the droplets are at least temporarily contained and differentiable, via initial coding based on spatiotemporal sequencing of the droplets and due to the droplets being introduced to the introduction or input region.

23. The apparatus of claim 22, further including:
a plurality of microfluidic containers to fluidically couple the respectively differentiable droplets with the microfluidic chamber or channel while the droplets are coded based on the spatiotemporal sequencing, wherein each of the plurality of microfluidic containers includes at least one of a microfluidic chamber and microchannel to store one of the respectively differentiable droplets before being introduced to the microfluidic channel; and
a microfluidic sample mixer to selectively pass the respectively differentiable droplets to the introduction or input region of the microfluidic chamber or channel using N-sample multiplexing. where W is an integer greater than 1, to cause the droplets to be coded with spatial positioning consistent with the spatiotemporal sequencing. and wherein the microfluidic chamber or channel includes an output region wherein the droplets are moved after passing through a main portion of the microfluidic channel.

24. The apparatus of claim 22, wherein in operation of the apparatus, the droplets are encoded via their movement into the microfluidic chamber or channel. towards or into the introduction or input region to form a temporal order that is at least partially preserved as a spatial pattern.

25. The apparatus of claim 22, wherein certain of the droplets of different groups are created to encapsulate or embrace respective chemicals, wherein each of the different groups contains a single type of molecule, and in at least one location within the microfluidic chamber or channel, and one type of the different groups is characterized as one or both of the following: the one type has a spatial order that is consistent with the spatiotemporal sequencing. and the one type has a spatial order within a secondary region of the chamber or channel that is monotonic with a temporal order associated with another region of the chamber or channel.
